(19) United States
(12) Patent Application Publication
(10) Pub. No.: US 2023/0234709 A1
(43) Pub. Date: Jul. 27, 2023

(54) SEAT ASSEMBLY HAVING STABLIZATION SYSTEM

(71) Applicant: THE BOEING COMPANY, Chicago, IL (US)

(72) Inventors: Amar Patel, Bangalore (IN); Praveen Varma, Bangalore (IN); Yashwanth Srinivassharma Theriyur, Bangalore (IN)

(73) Assignee: THE BOEING COMPANY, CHICAGO, IL (US)

(21) Appl. No.: 17/585,725

(22) Filed: Jan. 27, 2022

(51) Int. Cl. B64D 11/06

(52) U.S. Cl. CPC B64D 11/0642

(57) ABSTRACT

A seat assembly includes a seat cushion configured to support an individual, a backrest coupled to the seat cushion, a headrest coupled to the backrest, and one or more stabilization systems coupled to one or both of the backrest or the headrest. The one or more stabilization systems is moveable between a normal position and a stabilizing deployed position configured to stabilize a position of one or both of a head or a torso of the individual.

### FIELD OF THE DISCLOSURE

Examples of the present disclosure generally relate seat assemblies, and more particularly to seat assemblies having at least one stabilization system, such as can be used to stabilize passengers within an internal cabin of a vehicle, such as a commercial aircraft.

### BACKGROUND OF THE DISCLOSURE

Commercial aircraft typically include an internal cabin that may be divided into numerous sections. A cockpit is generally separated from a passenger cabin, which may include a first class section, a business class section, an economy section, and the like. Passengers within an internal cabin are typically seated on seat assemblies, which include a seat cushion, a backrest, and a headrest.

During a flight, a passenger may sleep while seated within a seat assembly. During such times, the passenger may inadvertently shift toward another seated passenger. For example, a head of a passenger may inadvertently slide from a headrest toward another, adjacent seat assembly.

### SUMMARY OF THE DISCLOSURE

A need exists for a system and a method for stabilizing a seated passenger during a flight, for example. Further, a need exists for a system and a method for reducing a likelihood of an individual encroaching upon the space of another passenger during a flight.

With those needs in mind, certain examples of the present disclosure provide a seat assembly including a seat cushion configured to support an individual, a backrest coupled to the seat cushion, a headrest coupled to the backrest, and one or more stabilization systems coupled to one or both of the backrest or the headrest. The one or more stabilization systems is moveable between a normal position and a stabilizing deployed position configured to stabilize a position of one or both of a head or a torso of the individual.

In at least one example, the one or more stabilization systems is coupled to the headrest. For example, the one or more stabilization systems includes a first side flap pivotally coupled to the headrest. The first side flap is configured to pivot in relation to a central head support of the headrest. A second side flap is pivotally coupled to the headrest. The second side flap is configured to pivot in relation to the central head support of the headrest.

In at least one example, the first side flap and the second side flap are flat in the normal position. The first side flap and the second side flap are outwardly pivoted in the stabilizing deployed position.

In at least one example, wherein each of the first side flap and the second side flap are pivotally coupled to a base panel of the headrest by hinges pivotally coupled to attachment brackets.

In at least one example, the first side flap and the second flap are configured to pivot about first pivot axes that are parallel to a central axis of the central head support. In at least one further example, the first side flap and the second side flap are configured to pivot about second pivot axes that are orthogonal to the first axes. In at least one further example, the first side flap and the second side flap are rotatably coupled to spherical bearings that provide degrees of rotational freedom in addition to the first pivot axes and the second pivot axes.

In at least one example, the one or more stabilization systems is coupled to the backrest. For example, the one or more stabilization systems includes a first panel pivotally coupled to a first side the backrest, and a second panel pivotally coupled to a second side the backrest.

In at least one example, the first panel and the second panel are closed and flat against a front surface of the backrest in the normal position. The first panel and the second panel are outwardly pivoted away from the front surface in the stabilizing deployed position.

In at least one example, the seat assembly also includes a supplemental cushion configured to be moved between a stowed position and a cushioning deployed position. The supplemental cushion, in the cushioning position, is configured to be disposed over the first panel and the second panel in the normal position. The supplemental cushion, in the cushioning position, is configured to be disposed over the front surface of the backrest when the one or more stabilization systems is in the stabilizing deployed position.

In at least one example, the supplemental cushion includes a flexible cushioned sheet rolled onto a roller shaft that is rotatably secured inside a portion of one or both of the headrest or the backrest. In at least one further example, the supplemental cushion also includes one or more roller springs coupled to one or both of the flexible cushioned sheet or the roller shaft.

In at least one example, the one or more stabilization systems is coupled to the backrest and the headrest.

In at least one example, the one or more stabilization systems includes a first stabilization system coupled to the backrest, and a second stabilization system coupled to the headrest.

Certain examples of the present disclosure provide a method of stabilizing an individual on a seat assembly. The method includes coupling one or more stabilization systems to one or both of a backrest or a headrest of the seat assembly; and moving the one or more stabilization systems between a normal position and a stabilizing deployed position configured to stabilize a position of one or both of a head or a torso of the individual.

Certain examples of the present disclosure provide a vehicle including an internal cabin, and a seat assembly within the internal cabin, as described herein.

### BRIEF DESCRIPTION OF THE DRAWINGS

FIG. 1 illustrates a perspective front view of a vehicle, according to an example of the present disclosure.

FIG. 2A illustrates a top plan view of an internal cabin of an aircraft, according to an example of the present disclosure.

FIG. 2B illustrates a top plan view of an internal cabin of an aircraft, according to an example of the present disclosure.

FIG. 3 illustrates a side view of a seat assembly, according to an example of the present disclosure.

FIG. 4 illustrates a schematic block diagram of a seat assembly, according to an example of the present disclosure.

FIG. 5 illustrates an isometric front view of a seat assembly including a stabilization system in a normal position, according to an example of the present disclosure.

FIG. 6 illustrates an isometric front view of the seat assembly of FIG. 5 in which the stabilization system is in a deployed position, according to an example of the present disclosure.

FIG. 7 illustrates an isometric front view of the seat assembly of FIG. 6 in which the stabilization system is in the deployed position and supporting and stabilizing a head of an individual.

FIG. 8 illustrates an isometric rear view of the stabilization system of FIGS. 5-7, according to an example of the present disclosure.

FIG. 9 illustrates a top view of the seat assembly including the stabilization system in the deployed position.

FIG. 10 illustrates a top view of a pivotal coupling of the stabilization system, according to an example of the present disclosure.

FIG. 11 illustrates an isometric front view of a stabilization system in a deployed position, according to an example of the present disclosure.

FIG. 12 illustrates an isometric front view of a first side flap being linearly slid away from a central head support of a headrest, according to an example of the present disclosure.

FIG. 13 illustrates an isometric front view of the first side flap of FIG. 12 being pivoted about a first pivot axis.

FIG. 14 illustrates an isometric front view of the first side flap of FIGS. 12 and 13 being pivoted about a second pivot axis that is orthogonal to the first pivot axis.

FIG. 15 illustrates an isometric front view of a stabilization system in a deployed position, according to an example of the present disclosure.

FIG. 16 illustrates an isometric front view of a seat assembly including a stabilization system in a normal position, according to an example of the present disclosure.

FIG. 17 illustrates an isometric front view of the seat assembly of FIG. 16 in which the stabilization system is in a deployed position, according to an example of the present disclosure.

FIG. 18 illustrates an isometric front view of the seat assembly of FIGS. 16 and 17 in which the stabilization system is in the deployed position and supporting and stabilizing a torso of an individual.

FIG. 19 illustrates an isometric front view of the seat assembly having the stabilization system in the deployed position and a supplemental cushion in a stowed position, according to an example of the present disclosure.

FIG. 20 illustrates an isometric front view of the seat assembly having the stabilization system in the normal position and the supplemental cushion in a deployed position, according to an example of the present disclosure.

FIG. 21 illustrates an isometric front view of the seat assembly having the stabilization system in the deployed position and the supplemental cushion in a deployed position, according to an example of the present disclosure.

FIG. 22 illustrates a side view of the seat assembly of FIG. 21.

FIG. 23 illustrates an isometric front view of a supplemental cushion, according to example of the present disclosure.

FIG. 24 illustrates a schematic block diagram of a seat assembly, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

Examples of the present disclosure provide a seat assembly having a stabilizing system that is configured to stabilize a position of a seated individual. The stabilizing system reduces a likelihood of the individual inadvertently encroaching upon the space of another seated individual. Further, by stabilizing a position of a seated passenger, the stabilizing system reduces a potential of fatigue, discomfort, and/or the like in relation to the seated individual. For example, the stabilizing system reduces a likelihood of neck and back discomfort that could potentially arise from resting in an awkward position.

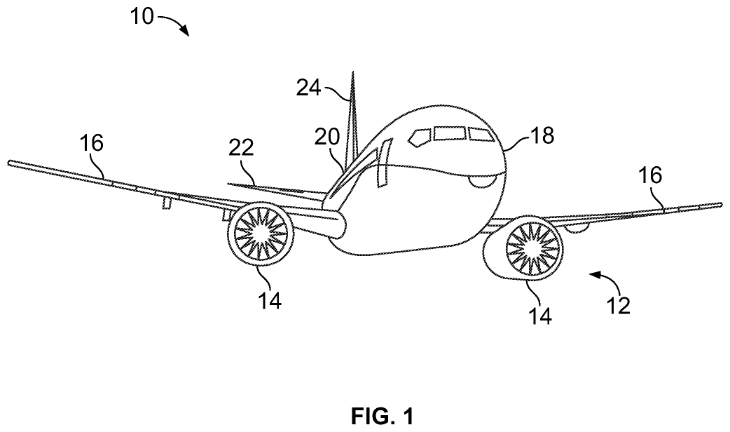

FIG. 1 illustrates a perspective top view of a vehicle, such as an aircraft 10, according to an example of the present disclosure. The aircraft 10 includes a propulsion system 12 that can include two turbofan engines 14, for example. Optionally, the propulsion system 12 can include more engines 14 than shown. The engines 14 are carried by wings 16 of the aircraft 10. In other embodiments, the engines 14 can be carried by a fuselage 18 and/or an empennage 20. The empennage 20 can also support horizontal stabilizers 22 and a vertical stabilizer 24.

The fuselage 18 of the aircraft 10 defines an internal cabin, which can be defined by interior sidewall panels that connect to a ceiling and a floor. The internal cabin can include a cockpit, one or more work sections (for example, galleys, personnel carry-on baggage areas, and the like), one or more passenger sections (for example, first class, business class, and economy sections), and/or the like. Overhead stowage bin assemblies can be positioned throughout the internal cabin.

Alternatively, instead of an aircraft, examples of the present disclosure may be used with various other vehicles, such as automobiles, buses, locomotives and train cars, seacraft, spacecraft, and the like. For example, seat assemblies having stabilizing systems can be used with various vehicles. Also, examples of the present disclosure can be used in fixed structures, such as residential and/or commercial buildings.

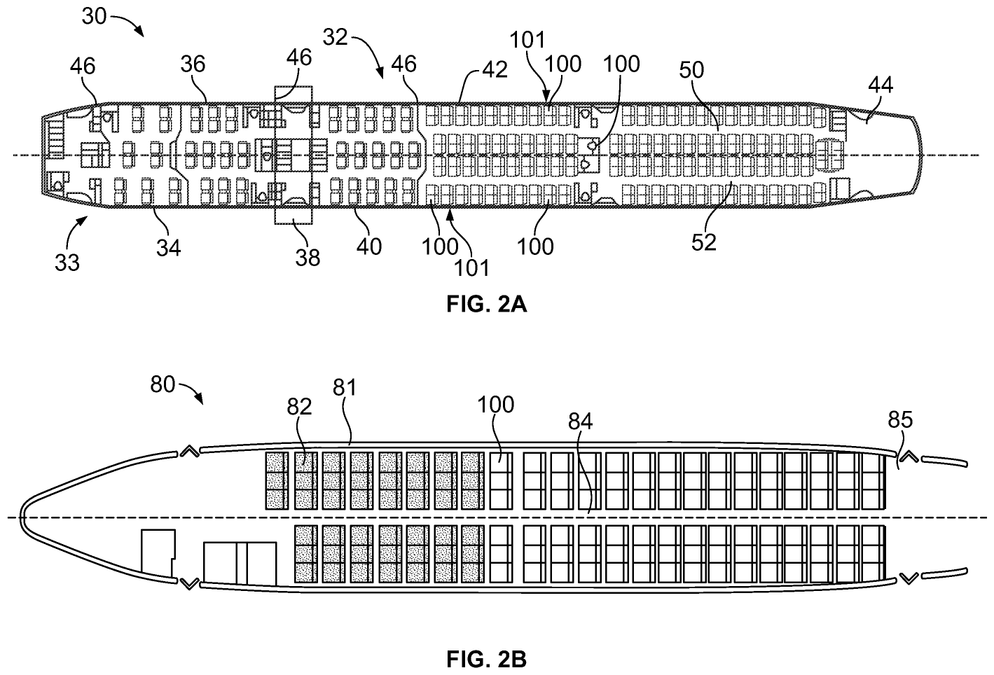

FIG. 2A illustrates a top plan view of an internal cabin 30 of an aircraft, according to an example of the present disclosure. The internal cabin 30 can be within a fuselage 32 of the aircraft. For example, one or more fuselage walls can define an interior of the internal cabin 30. The interior of the internal cabin 30 is defined by sidewall panels that connect to a ceiling and a floor. The sidewall panels include lateral segments that connect to ceiling segments. The lateral segments define lateral wall portions, while the ceiling segments define at least portions of the ceiling within the internal cabin 30.

The internal cabin 30 includes multiple sections, including a front section 33, a first class section 34, a business class section 36, a front galley station 38, an expanded economy or coach section 40, a standard economy or coach section 42, and an aft section 44, which may include multiple lavatories and galley stations. It is to be understood that the internal cabin 30 can include more or less sections than shown. For example, the internal cabin 30 may not include a first class section, and may include more or less galley stations than shown. Each of the sections may be separated by a cabin transition area 46.

As shown in FIG. 2A, the internal cabin 30 includes two aisles 50 and 52 that lead to the aft section 44. Optionally, the internal cabin 30 can have less or more aisles than shown. For example, the internal cabin 30 can include a single aisle that extends through the center of the internal cabin 30 that leads to the aft section 44. Seat assemblies 100 are positioned throughout the internal cabin 30. The seat assemblies 100 may be arranged in rows 101.

FIG. 2B illustrates a top plan view of an internal cabin 80 of an aircraft, according to an embodiment of the present disclosure. The internal cabin 80 can be within a fuselage 81 of the aircraft. For example, one or more fuselage walls may define the interior of the internal cabin 80. The internal cabin 80 includes multiple sections, including a main cabin 82 having passenger seat assemblies 100, and an aft section 85 behind the main cabin 82. It is to be understood that the internal cabin 80 may include more or less sections than shown.

The internal cabin 80 can include a single aisle 84 that leads to the aft section 85. The single aisle 84 can extend through the center of the internal cabin 80 that leads to the aft section 85. For example, the single aisle 84 can be coaxially aligned with a central longitudinal plane of the internal cabin 80.

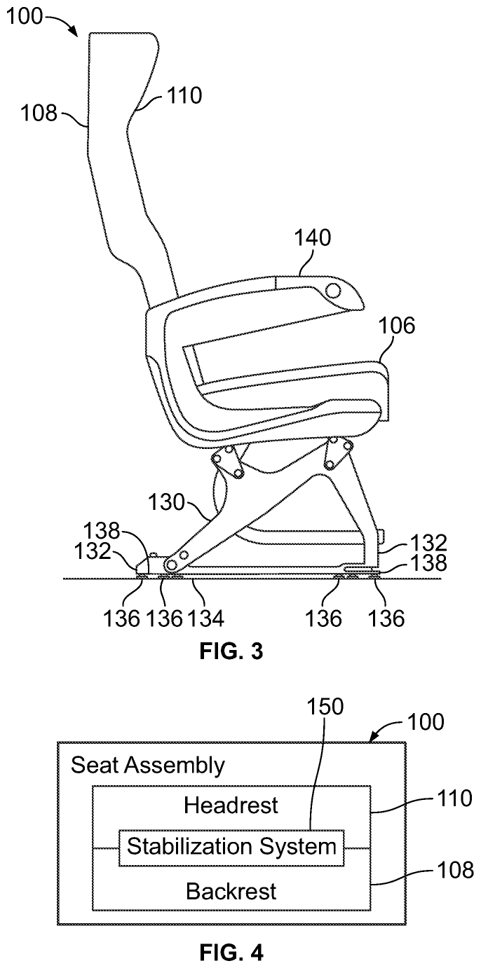

FIG. 3 illustrates a side view of a seat assembly 100, according to an example of the present disclosure. In at least one example, the seat assembly 100 is configured to be secured within an internal cabin of a vehicle, such as a commercial aircraft.

The seat assembly 100 includes a base 130, which may include legs 132 that may be secured to seat tracks 134 within an internal cabin of a vehicle. In at least one embodiment, securing studs 136 (such as shear studs) downwardly extend from lower surfaces 138 of the legs 132. The securing studs 136 are securely retained within the seat tracks 134. The seat tracks 134 are configured to securely couple to the securing studs 136 to secure the seat assembly 100 in place. The base 130 supports a seat cushion 106 and a backrest 108, A headrest 110 upwardly extends from the backrest 108. Armrests 140 may be pivotally secured to the backrest 108.

The seat assembly 100 may be sized and shaped differently than shown in FIG. 3. The seat assembly 100 may include more or less components than shown in FIG. 3. It is to be understood that the seat assembly 100 shown in FIG. 3 is merely one example of a seat assembly that can be disposed within an internal cabin of a vehicle.

FIG. 4 illustrates a schematic block diagram of a seat assembly 100, according to an example of the present disclosure. The seat assembly 100 includes a backrest 108 and a headrest 110. The seat assembly 100 further includes a stabilization system 150. As described herein, the stabilization system 150 is coupled to one or both of the backrest 108 and/or the headrest 110.

In at least one example, the headrest 110 includes the stabilization system 150. The stabilization system 150 is coupled to the headrest 110.

In another example, the backrest 108 includes the stabilization system 150. The stabilization system 150 is coupled to the backrest 108.

In another example, the stabilization system 150 is part of the backrest 108 and the headrest 110. The stabilization system 150 is coupled to both the backrest 108 and the headrest 110.

In another example, the backrest 108 includes a first stabilization system 150, and the headrest 110 includes a second stabilization system 150 that differs from the first stabilization system 150. The first stabilization system 150 is coupled to the headrest 110, and the second stabilization system 150 is coupled to the backrest 108.

In an example, the headrest 110 includes the stabilization system 150 (for example, the stabilization system 150 is coupled to the headrest 110). In this example, the stabilization system 150 includes side flaps that are configured to be adjustable in relation to a head of a seated individual. The side flaps are moveable between a normal position, such as a flat position, and pivoted positions, in which the side flaps are pivoted in relation to the head of the individual to support and stabilize the head of the seated individual.

In another example, the backrest 110 includes the stabilization system 150 (for example, the stabilization system 150 is coupled to the backrest 108). In this example, the stabilization system 150 includes moveable panels that are configured to be adjustable in relation to a torso of a seated individual. The panels are moveable between a normal position, such as a flat position, and pivoted positions, which the panels are pivoted in relation to the torse of the individual to support and stabilize the torso of the seated individual.

In at least one other example, the headrest 110 of the seat assembly 100 includes the stabilization system including the moveable side flaps, as described herein, and the backrest 108 of the seat assembly 100 includes the moveable panels, as described herein.

As described herein, the seat assembly 100 includes at least one stabilization system 150 that is configured to stabilize a portion of a seated individual. The headrest 110 and/or the backrest 108 includes the stabilization system 150. The stabilization system 150 includes one or more moveable portions that are configured to be moved between a normal position (such as a flat position in relation to one or both of the headrest 110 and/or the backrest 108), and a deployed position, in which the moveable portions are outwardly pivoted out of a plane of a portion of either the headrest 110 and/or the backrest 108.

As described herein, the seat assembly 100 includes a seat cushion (such as the seat cushion 106 shown in FIG. 3) configured to support an individual. The backrest 108 is coupled to the seat cushion. The headrest 110 is coupled to the backrest. One or more stabilization systems 150 is coupled to one or both of the backrest 108 and/or the headrest 110. The one or more stabilization systems 150 are moveable between a normal position (in which one components of the stabilization system 150 are generally flat), and a stabilizing deployed position configured to stabilize a position of one or both of a head or a torso of the individual.

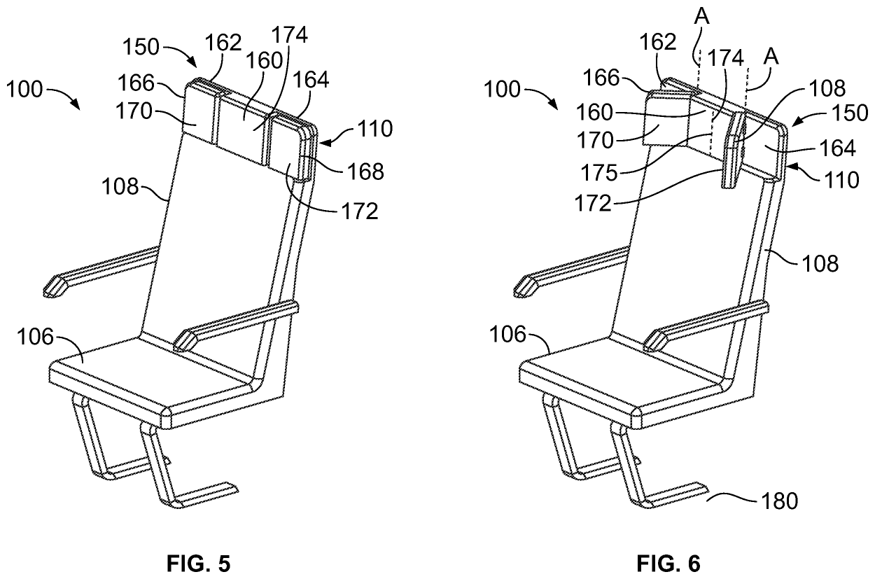

FIG. 5 illustrates an isometric front view of a seat assembly 100 including a stabilization system 150 in a normal position, according to an example of the present disclosure. In at least one example, the headrest 110 includes the stabilization system 150. The headrest 110 includes a central head support 160 between a first lateral recess 162 and a second lateral recess 164. The stabilization system 150 includes a first side flap 166 moveably secured within the first lateral recess 162, and a second side flap 168 moveably secured with the second lateral recess 164. The central head support 160, the first side flap 166, and the second side flap 168 can be cushioned to provide comfort and support to a head of a seated individual.

In the normal position, the first side flap 166 and the second side flap 168 are flat. For example, the first side flap 166 and the second flap 168 are generally aligned with the central head support 160. In particular, an outer surface 170 of the first side flap 166, and an outer surface 172 of the second side flap 168 are coplanar (or substantially coplanar) with an outer surface 174 of the central head support 160 when the stabilization system 150 is in the normal position. Conversely, the first side flap 166 and the second side flap 168 are outwardly pivoted (and no longer flat) in the stabilizing deployed position.

FIG. 6 illustrates an isometric front view of the seat assembly 100 of FIG. 5 in which the stabilization system 150 is in a deployed position, according to an example of the present disclosure. In the deployed position, the first side flap 166 and the second side flap 168 are pivoted away from the respective first lateral recess 162 and the second lateral recess 164, such that the outer surface 170 of the first side flap 166 and the outer surface 172 of the second side flap 168 are no longer coplanar with the outer surface 174 of the central head support 160.

As shown in FIG. 6, the first side flap 166 and the second side flap 168 are configured to pivot about axes A. In at least one example, the axes A are parallel to a central axis 175 (such as a central vertical axis) of the central head support 160. The axes A can be vertical axes in relation to a floor 180 on which the seat assembly 100 is positioned.

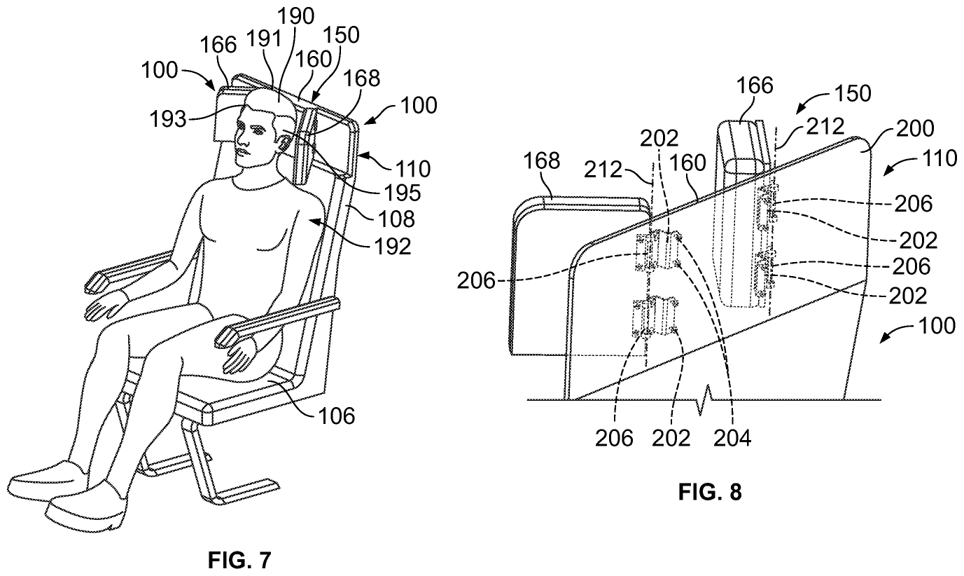

FIG. 7 illustrates an isometric front view of the seat assembly 100 of FIG. 6 in which the stabilization system 150 is in the deployed position and supporting and stabilizing a head 190 of an individual 192. The rear 191 of the head 190 is supported by the central head support 160. The first side flap 166 in the deployed position provides a lateral boundary for a first side 193 of the head 190, thereby ensuring that the head 190 does not fall off to a first side of the headrest 110. The second side flap 168 in the deployed position provides a lateral boundary for a second side 195 of the head 190, thereby ensuring that the head 190 does not fall off to an opposite second side of the headrest 110.

FIG. 8 illustrates an isometric rear view of the stabilization system 150 of FIGS. 5-7, according to an example of the present disclosure. As shown, each of the first side flap 166 and the second side flap 168 is pivotally coupled to a base panel 200 of the headrest 110. For the sake of clarity, the base panel 200 is shown as transparent, and cushioning portions of the central head support 160, for example, are not shown.

Attachment brackets 202 are secured to the base panel 200, such as by one or more fasteners 204. Hinges 206 are coupled to the attachment brackets 202. As shown, each of the first side flap 166 and the second side flap 168 is coupled to two attachment brackets 202 by two hinges 206. The hinges 206 coupled to the first side flap 166 are coaxial to define a first pivot axis 210 (which is coaxial or otherwise parallel with the axis A, shown in FIG. 6), and the hinges 206 coupled to the second side flap 168 are coaxial to define a second pivot axis 212 (which is coaxial or otherwise parallel with the axis A, shown in FIG. 6). The hinges 206 can be friction hinges, which are configured to remain in desired positions until a predetermined amount of force is applied thereto. As such, an individual can move the first side flap 166 and the second side flap 168 to desired positions, which are maintained until the individual decides to pivot the first side flap 166 and/or the second side flap 168 to different positions.

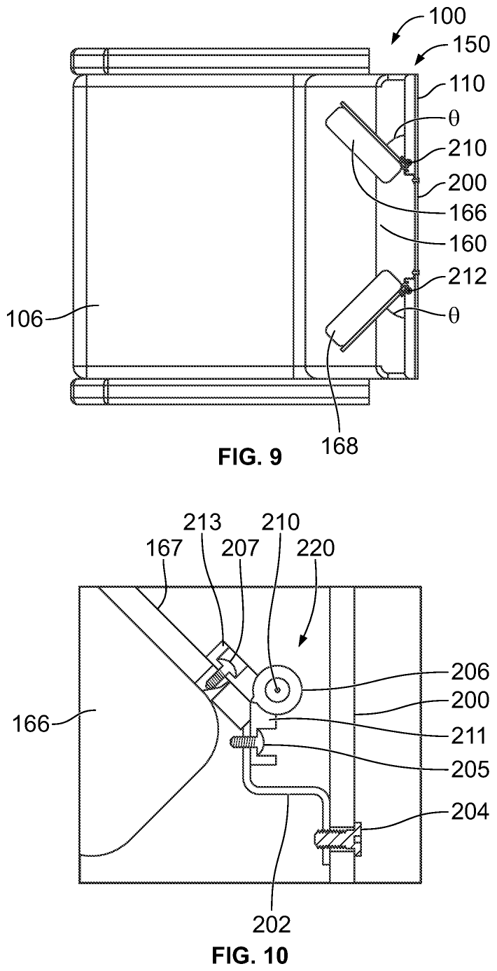

FIG. 9 illustrates a top view of the seat assembly 100 including the stabilization system 150 in the deployed position. As shown, the first side flap 166 and the second side flap 168 can be pivoted between the normal position (shown in FIG. 5), and a deployed position about respective pivot axes 210 and 212 through various desired angles 0. The individual can adjust the positions of the first side flap 166 and/or the second side flap 168 at various angular positions in relation to the central head support 160 to provide a desired amount of lateral head support and stabilization.

FIG. 10 illustrates a top view of a pivotal coupling 220 of the stabilization system, according to an example of the present disclosure. In at least one example, the pivotal coupling 220 is defined by the pivot axis 210 defined by the aligned hinges 206. It is to be understood that the pivotal coupling for the second side flap 168 (shown in FIG. 9, for example) is similarly configured. Referring to FIGS. 8-10, the brackets 202 are secured to the base panel 200 of the headrest 110, such as via fasteners 204. The hinges 206 include first portions 211 secured to the brackets 202, such as via fasteners 205, and second portions 213 secured to a backing panel 167 of the first side flap 166, such as via fasteners 207. The pivot coupling 220 shown in FIG. 10 is merely exemplary. The components of the pivotal coupling 220, such as the brackets 202 and hinges 206 can be sized, shaped, and configured differently than shown.

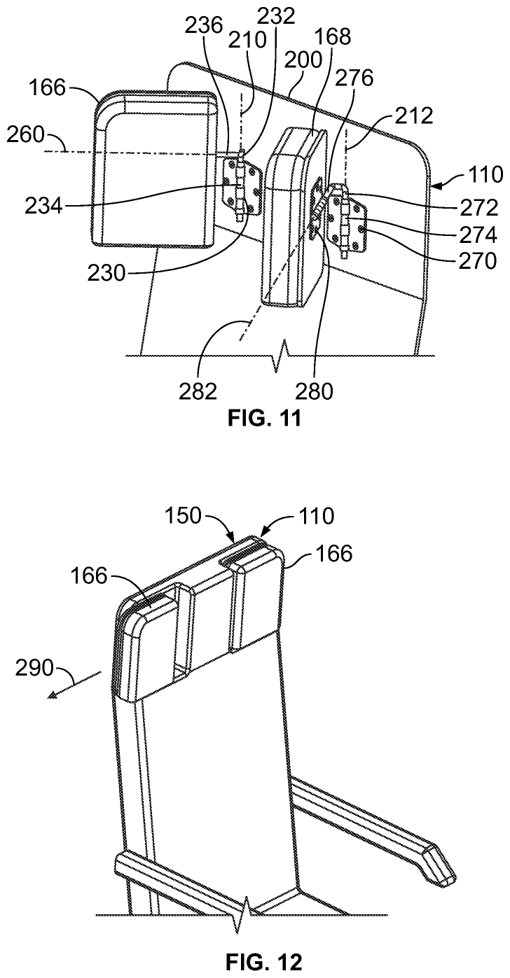

FIG. 11 illustrates an isometric front view of a stabilization system 150 in a deployed position, according to an example of the present disclosure. In this example, the first side flap 166 is coupled to the base panel 200 of the headrest 110 by a first hinge 230 that provides pivotal motion about the first pivot axis 210. For example, a first rotation beam 232 is pivotally retained within a first hinge bearing 234. A second rotation beam 236 extends orthogonally from a top of the first rotation beam 232 and is pivotally retained within a second hinge bearing secured to a rear of the first side flap 166. The second rotation beam 236 can be a telescoping arm, for example. In this manner, the first side flap 166 is configured to rotate about the first pivot axis 210, and a second pivot axis 260 that is orthogonal to the first pivot axis 210, thereby providing two different degrees of rotational capability.

Similarly, the second side flap 168 is coupled to the base panel 200 of the headrest 110 by a first hinge 270 (or third hinge) that provides pivotal motion about the pivot axis 212. For example, a first rotation beam 272 is pivotally retained within a first hinge bearing 274. A second rotation beam 276 (such as a telescoping arm) extends orthogonally from a top of the first rotation beam 272 and is pivotally retained within a second hinge bearing 280 secured to a rear of the second side flap 168. In this manner, the second side flap 168 is configured to rotate about the first pivot axis 212, and a second pivot axis 282 that is orthogonal to the first pivot axis 212, thereby providing two different degrees of rotational capability.

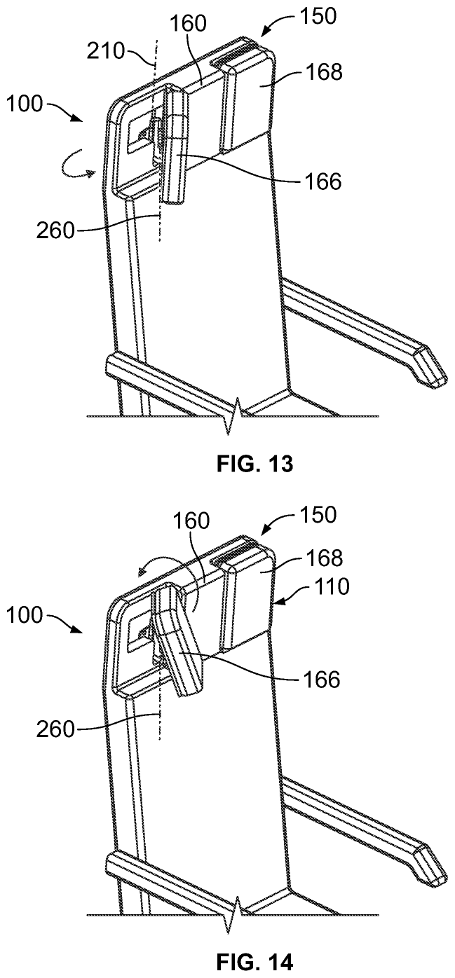

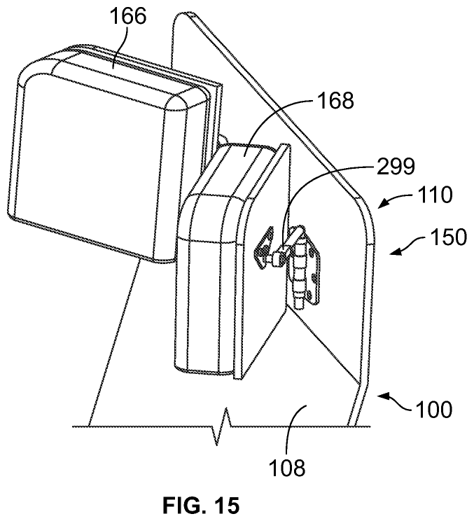

FIG. 12 illustrates an isometric front view of the first side flap 166 being linearly slid away from the central head support 160 of the headrest 110, according to an example of the present disclosure. For example, the first side flap 166 can be outwardly slid, such as by the hinge bearing sliding outwardly over the second rotation beam 236, in the direction 290. The first side flap 166 can be outwardly slid as shown in order to provide clearance between the first side flap 166 and the central head support 160 for the first side flap 166 to rotate about the second pivot axis 260. FIG. 13 illustrates an isometric front view of the first side flap 166 of FIG. 12 being pivoted about the first pivot axis 210. FIG. 14 illustrates an isometric front view of the first side flap 166 of FIGS. 12 and 13 being pivoted about the second pivot axis 260 that is orthogonal to the first pivot axis 210. The second side flap 168 can be moved in a similar fashion as described with respect to FIGS. 12-14.

FIG. 15 illustrates an isometric front view of a stabilization system 150 in a deployed position, according to an example of the present disclosure. The first side flap 166 and the second side flap 168 can also be coupled to respective rotation beams by spherical bearings 299, such as ball and socket couplings. The spherical bearings 299 allow for additional degrees of rotational freedom. Thus, the first side flap 166 and the second side flap 168 are configured to pivot about first axes, second axes that are orthogonal to the first axes, and the spherical bearings 299.

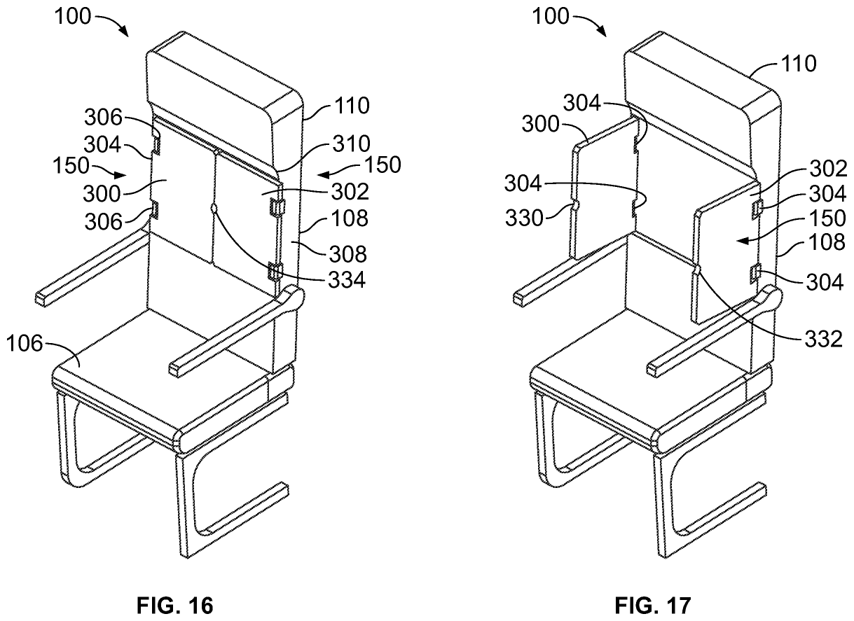

FIG. 16 illustrates an isometric front view of a seat assembly 100 including a stabilization system 150 in a normal position, according to an example of the present disclosure. In this example, the stabilization system 150 is coupled to the backrest 108. For example, the backrest 108 includes the stabilization system 150.

The stabilization system 150 includes a first panel 300 and a second panel 302, each of which is configured to move relative to the backrest 108. The first panel 300 is pivotally coupled to a first side 304 of the backrest 108, such as through one or more hinges 306. The second panel 302 is pivotally coupled to a second side 308 of the backrest 108, such as through one or more hinges 306. The first panel 300 and the second panel 302 can be flat, cushioned panels. In the normal position, the first panel 300 and the second panel 302 are closed and generally flat against a front surface 310 of the backrest 108. In the normal position, the first panel 300 and the second panel 302 can be coplanar.

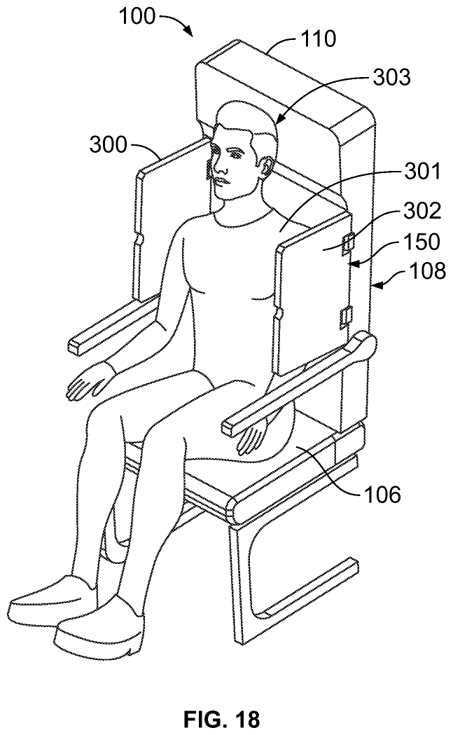

FIG. 17 illustrates an isometric front view of the seat assembly 100 of FIG. 16 in which the stabilization system 150 is in a deployed position, according to an example of the present disclosure. FIG. 18 illustrates an isometric front view of the seat assembly 100 of FIGS. 16 and 17 in which the stabilization system 150 is in the deployed position and supporting and stabilizing a torso 301 of an individual 303. Referring to FIGS. 16-18, in the deployed position, the first panel 300 and the second panel 302 are pivoted outwardly away from the front surface 310 of the backrest 108 about the respective hinges 304. In the deployed position, the first panel 300 and the second panel 302 can be orthogonal to the front surface 310. In the deployed position, the first panel 300 and the second panel 302 provide boundaries that limit lateral motion of a torso of an individual, thereby constraining the individual 303 between the first panel 300 and the second panel 302.

Each of the first panel 300 and the second panel 302 can include a cutout 330 and 332, respectively. When the first panel 300 and the second panel 302 are closed in the normal position, as shown in FIG. 16, the cutouts 330 and 332 are aligned within one another in a mirrored relationship, thereby providing a central opening 334. The central opening 334 provides a readily accessible, recognizable, and non-obtrusive area where an individual can grasp the respective first panel 300 and the second panel 302, in order to easily pivot the first panel 300 and the second panel 302 into the deployed position.

In at least one example, the seat assembly 100 includes any of the examples of the stabilization systems 150 shown with respect to FIGS. 5-15, as well as the stabilization system 150 shown with respect to FIGS. 16-18. For example, the seat assembly 100 includes any of the stabilization systems 150 coupled to the headrest 110, as shown in FIGS. 5-15, as well as the stabilization system 150 coupled to the backrest 108, as shown in FIGS. 16-18.

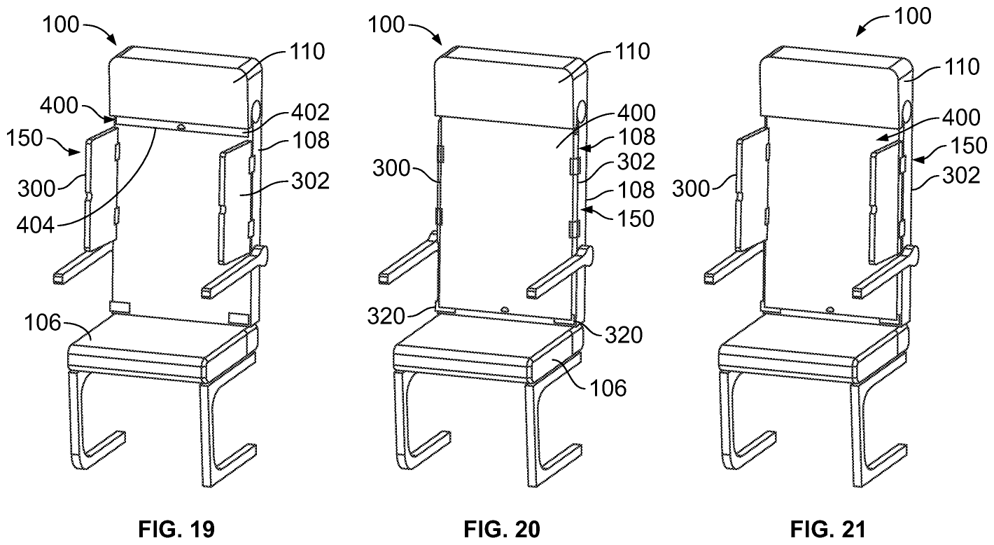

FIG. 19 illustrates an isometric front view of the seat assembly 100 having the stabilization system 150 in the deployed position and a supplemental cushion 400 in a stowed position, according to an example of the present disclosure. In at least one example, the supplemental cushion 400 is a rolled sleeve 402 of cushioned material. The rolled sleeve 402 can be rotatably secured underneath the headrest 110, and above the stabilization system 150. An individual can pull an exposed end 404 of the rolled sleeve 402 toward the seat cushion 106 to unroll the rolled sleeve 402 and deploy the supplemental cushion 400.

FIG. 20 illustrates an isometric front view of the seat assembly 100 having the stabilization system 150 in the normal position and the supplemental cushion 400 in a deployed position, according to an example of the present disclosure. The first panel 300 and the second panel 302 are folded flat in the normal position against the backrest 108. The supplemental cushion 400 can be unrolled over the first panel 300 and the second panel 302 to provide additional cushioning support for a seated individual.

As shown, securing anchors 320 can be secured to one or both of the backrest 108 proximate to the seat cushion 106, and/or the seat cushion 106 itself. The securing anchors 320 are configured to secure to reciprocal features of the exposed end 404 of the supplemental cushion 400 to hold the supplemental cushion 400 in the deployed position. For example, the securing anchors 320 can be hooks, loops, clasps, rings, tabs, slots, adhesive tape, and/or the like that mate with reciprocal features of the supplemental cushion 400. In at least one example, the securing anchors 320 and the supplemental cushion 400 include hook and loop fasteners, such as Velcro.

FIG. 21 illustrates an isometric front view of the seat assembly 100 having the stabilization system 150 in the deployed position and the supplemental cushion 400 in a deployed position, according to an example of the present disclosure. As shown, the first panel 300 and the second panel 302 can be pivoted outwardly into the deployed position (for example, a stabilizing deployed position) to provide stabilizing support for a seated individual, and the supplemental cushion 400 can be unrolled into the deployed position (for example, a cushioning deployed position) to provide additional cushioning support for the seated individual.

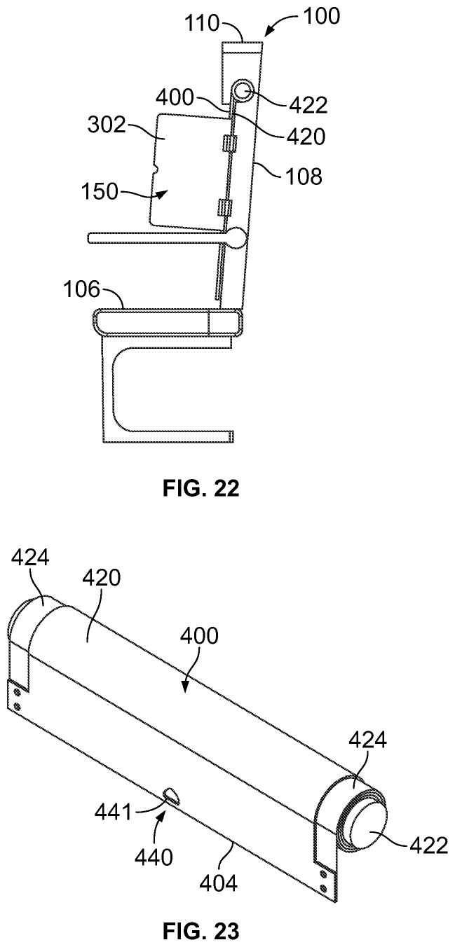

FIG. 22 illustrates a side view of the seat assembly 100 of FIG. 21. FIG. 23 illustrates an isometric front view of the supplemental cushion 400, according to example of the present disclosure. Referring to FIGS. 22 and 23, the supplemental cushion 400 includes a flexible cushioned sheet 420 rolled onto a roller shaft 422 that is rotatably secured inside a portion of one or both of the headrest 110 and/or the backrest 108. Roller springs 424 are coupled to the cushioned sheet 420 and/or the roller shaft 422, such as via fasteners and/or adhesives. An opening 440 can be formed through a portion of the exposed end 404. The opening 440 provides a location where an individual can grasp internal edges 441 of the cushioned sheet 420 in order to pull the cushioned sheet 420 downwardly. The roller springs 424 are configured to exert a resistive force to rotate the roller shaft 422 to pull the cushioned sheet 420 back to stowed position, in which the cushioned sheet 420 is rolled around the roller shaft 422.

FIGS. 22 and 23 show an example of a supplemental cushion that is configured to be moved between a stowed position and a deployed position, as described, Optionally, the supplemental cushion can be sized, shaped, and configured differently than shown. For example, the supplemental cushion can be flat cushion that is stowed in relation to the seat assembly (such as stowed under the seat assembly, within a stowage bin assembly, or the like) that is configured to be selectively positioned on and removed from the backrest 108. The supplemental cushion can be used with any of the example of the present disclosure described herein.

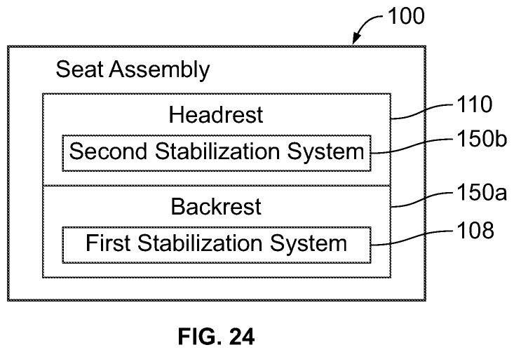

FIG. 24 illustrates a schematic block diagram of a seat assembly 100, according to an example of the present disclosure. As described herein, one or more stabilization systems 150 is coupled to the backrest 108 and/or the headrest 110. For example, a first stabilization system 150a is coupled to the backrest 108, and a second stabilization system 150b coupled to the headrest 110.

It is to be understood that the terms first, second, third, etc., as used herein, are merely to identify different numbers of components. The terms can be interchangeable. For example, the backrest 108 can include the second stabilization system 150b, and the headrest 110 can include the first stabilization system 150a.

Further, the disclosure comprises examples according to the following clauses:

Clause 1. A seat assembly comprising:

a seat cushion configured to support an individual;

a backrest coupled to the seat cushion;

a headrest coupled to the backrest; and

one or more stabilization systems coupled to one or both of the backrest or the headrest, wherein the one or more stabilization systems is moveable between a normal position and a stabilizing deployed position configured to stabilize a position of one or both of a head or a torso of the individual.

Clause 2. The seat assembly of Clause 1, wherein the one or more stabilization systems is coupled to the headrest.

Clause 3. The seat assembly of Clause 2, wherein the one or more stabilization systems comprises:

a first side flap pivotally coupled to the headrest, wherein the first side flap is configured to pivot in relation to a central head support of the headrest; and

a second side flap pivotally coupled to the headrest, wherein the second side flap is configured to pivot in relation to the central head support of the headrest.

Clause 4. The seat assembly of Clause 3, wherein the first side flap and the second side flap are flat in the normal position, and wherein the first side flap and the second side flap are outwardly pivoted in the stabilizing deployed position.

Clause 5. The seat assembly of Clauses 3 or 4, wherein each of the first side flap and the second side flap are pivotally coupled to a base panel of the headrest by hinges pivotally coupled to attachment brackets.

Clause 6. The seat assembly of any of Clauses 3-5, wherein the first side flap and the second flap are configured to pivot about first pivot axes that are parallel to a central axis of the central head support.

Clause 7. The seat assembly of Clause 6, wherein the first side flap and the second side flap are configured to pivot about second pivot axes that are orthogonal to the first axes.

Clause 8. The seat assembly of Clause 7, wherein the first side flap and the second side flap are rotatably coupled to spherical bearings that provide degrees of rotational freedom in addition to the first pivot axes and the second pivot axes.

Clause 9. The seat assembly of any of Clause 1, wherein the one or more stabilization systems is coupled to the backrest.

Clause 10. The seat assembly of Clause 9, wherein the one or more stabilization systems comprises:

a first panel pivotally coupled to a first side the backrest; and

a second panel pivotally coupled to a second side the backrest.

Clause 11. The seat assembly of Clause 10, wherein the first panel and the second panel are closed and flat against a front surface of the backrest in the normal position, and wherein the first panel and the second panel are outwardly pivoted away from the front surface in the stabilizing deployed position.

Clause 12. The seat assembly of Clause 11, further comprising a supplemental cushion configured to be moved between a stowed position and a cushioning deployed position, wherein the supplemental cushion, in the cushioning position, is configured to be disposed over the first panel and the second panel in the normal position, and wherein the supplemental cushion, in the cushioning position, is configured to be disposed over the front surface of the backrest when the one or more stabilization systems is in the stabilizing deployed position.

Clause 13. The seat assembly of Clause 12, wherein the supplemental cushion comprises a flexible cushioned sheet rolled onto a roller shaft that is rotatably secured inside a portion of one or both of the headrest or the backrest.

Clause 14. The seat assembly of Clause 13, wherein the supplemental cushion further comprises one or more roller springs coupled to one or both of the flexible cushioned sheet or the roller shaft.

Clause 15. The seat assembly of any of Clauses 1-14, wherein the one or more stabilization systems is coupled to the backrest and the headrest.

Clause 16. The seat assembly of any of Clauses 1-15, wherein the one or more stabilization systems comprises a first stabilization system coupled to the backrest, and a second stabilization system coupled to the headrest.

Clause 17. A method of stabilizing an individual on a seat assembly, the method comprising:

coupling one or more stabilization systems to one or both of a backrest or a headrest of the seat assembly; and

moving the one or more stabilization systems between a normal position and a stabilizing deployed position configured to stabilize a position of one or both of a head or a torso of the individual.

Clause 18. A vehicle comprising:

an internal cabin;

a seat assembly within the internal cabin, the seat assembly comprising:
a seat cushion configured to support an individual;
a backrest coupled to the seat cushion;
a headrest coupled to the backrest; and
one or more stabilization systems coupled to one or both of the backrest or the headrest, wherein the one or more stabilization systems is moveable between a normal position and a stabilizing deployed position configured to stabilize a position of one or both of a head or a torso of the individual.

Clause 19. The vehicle of Clause 18, wherein the one or more stabilization systems is coupled to the headrest.

Clause 20. The vehicle of Clause 18, wherein the one or more stabilization systems is coupled to the backrest.

As described herein, examples of the present disclosure provide systems and methods for stabilizing seated passengers during travel. Further, examples of the present disclosure provide systems and methods for reducing a likelihood of an individual encroaching upon the space of another passenger during a flight.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the parameters of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A seat assembly comprising:
a seat cushion configured to support an individual;
a backrest coupled to the seat cushion;
a headrest coupled to the backrest; and
one or more stabilization systems coupled to one or both of the backrest or the headrest, wherein the one or more stabilization systems is moveable between a normal position and a stabilizing deployed position configured to stabilize a position of one or both of a head or a torso of the individual.

2. The seat assembly of claim 1, wherein the one or more stabilization systems is coupled to the headrest.

3. The seat assembly of claim 2, wherein the one or more stabilization systems comprises:
a first side flap pivotally coupled to the headrest, wherein the first side flap is configured to pivot in relation to a central head support of the headrest; and
a second side flap pivotally coupled to the headrest, wherein the second side flap is configured to pivot in relation to the central head support of the headrest.

4. The seat assembly of claim 3, wherein the first side flap and the second side flap are flat in the normal position, and wherein the first side flap and the second side flap are outwardly pivoted in the stabilizing deployed position.

5. The seat assembly of claim 3, wherein each of the first side flap and the second side flap are pivotally coupled to a base panel of the headrest by hinges pivotally coupled to attachment brackets.

6. The seat assembly of claim 3, wherein the first side flap and the second flap are configured to pivot about first pivot axes that are parallel to a central axis of the central head support.

7. The seat assembly of claim 6, wherein the first side flap and the second side flap are configured to pivot about second pivot axes that are orthogonal to the first axes.

8. The seat assembly of claim 7, wherein the first side flap and the second side flap are rotatably coupled to spherical bearings that provide degrees of rotational freedom in addition to the first pivot axes and the second pivot axes.

9. The seat assembly of claim 1, wherein the one or more stabilization systems is coupled to the backrest.

10. The seat assembly of claim 9, wherein the one or more stabilization systems comprises:
a first panel pivotally coupled to a first side the backrest; and
a second panel pivotally coupled to a second side the backrest.

11. The seat assembly of claim 10, wherein the first panel and the second panel are closed and flat against a front surface of the backrest in the normal position, and wherein the first panel and the second panel are outwardly pivoted away from the front surface in the stabilizing deployed position.

12. The seat assembly of claim 11, further comprising a supplemental cushion configured to be moved between a stowed position and a cushioning deployed position, wherein the supplemental cushion, in the cushioning position, is configured to be disposed over the first panel and the second panel in the normal position, and wherein the supplemental cushion, in the cushioning position, is configured to be disposed over the front surface of the backrest when the one or more stabilization systems is in the stabilizing deployed position.

13. The seat assembly of claim 12, wherein the supplemental cushion comprises a flexible cushioned sheet rolled onto a roller shaft that is rotatably secured inside a portion of one or both of the headrest or the backrest.

14. The seat assembly of claim 13, wherein the supplemental cushion further comprises one or more roller springs coupled to one or both of the flexible cushioned sheet or the roller shaft.

15. The seat assembly of claim 1, wherein the one or more stabilization systems is coupled to the backrest and the headrest.

16. The seat assembly of claim 1, wherein the one or more stabilization systems comprises a first stabilization system coupled to the backrest, and a second stabilization system coupled to the headrest.

17. A method of stabilizing an individual on a seat assembly, the method comprising:
coupling one or more stabilization systems to one or both of a backrest or a headrest of the seat assembly; and
moving the one or more stabilization systems between a normal position and a stabilizing deployed position configured to stabilize a position of one or both of a head or a torso of the individual.

18. A vehicle comprising:
an internal cabin; and
a seat assembly within the internal cabin, the seat assembly comprising:
a seat cushion configured to support an individual;
a backrest coupled to the seat cushion;
a headrest coupled to the backrest; and
one or more stabilization systems coupled to one or both of the backrest or the headrest, wherein the one or more stabilization systems is moveable between a normal position and a stabilizing deployed position configured to stabilize a position of one or both of a head or a torso of the individual.

19. The vehicle of claim 18, wherein the one or more stabilization systems is coupled to the headrest.

20. The vehicle of claim 18, wherein the one or more stabilization systems is coupled to the backrest.
